(19) United States
(12) Patent Application Publication
(10) Pub. No.: US 2006/0253842 A1
(43) Pub. Date: Nov. 9, 2006

(54) Modelling of programmable devices

(75) Inventors: Stefan Leo Alexander Pees, Aachen (DE); Johannes George Overmann, Aachen (DE)

Correspondence Address: NIXON & VANDERHYE, PC, 901 NORTH GLEBE ROAD, 11TH FLOOR, ARLINGTON, VA, 22203, US

(73) Assignee: ARM LIMITED, Cambridge (GB)

(21) Appl. No.: 11/250,496

(22) Filed: Oct. 17, 2005

(30) Foreign Application Priority Data
May 5, 2005 (GB) 0509201.0

(51) Int. Cl. G06F 9/44

(52) U.S. Cl. 717/129

(57) ABSTRACT

Simulation of a target programmable device executing target program code is provided by simulation code 2. A simulation host debugger 10 provides access to host resources for debugging the simulation code 2. A target device debugger 18 issues access requests to a debug interface 6 within the simulation code 2 to recover target resource information indicating the state of the modelled target programmable device in executing its target program code. In this way, simultaneous debugging of the simulation of a target programmable device as well as the target program code executing in simulated form on that target programmable device may be provided.

### BACKGROUND OF THE INVENTION

1. Field of the Invention

This invention relates to the field of modelling electronic devices. More particularly, this invention relates to the field of modelling programmable devices executing program instructions.

2. Description of the Prior Art

It is known to provide models of data processing devices, such as microprocessors, DSPs, etc, which may be used to investigate the behaviour of these devices. Such models are often used in the design and development stage of new programmable devices to explore the capabilities of those devices without the need for the real devices to be produced. Furthermore, programmable devices also need suitable programs to be developed to be run upon them and it is desirable to be able to model the behaviour of such programs before the real devices become available. Modelling in this way helps to identify potential problems early in the development process such that those problems can be overcome relatively easily and inexpensively by appropriate design changes. Being able to develop programs in parallel with the hardware upon which they will execute also reduces overall development time, which is advantageous.

In order to address the above requirements it is known to provide modelling tools such as MaxCore produced by ARM Limited of Cambridge England. Such tools are able to take a formal definition of the behavioural characteristics of a new programmable device, such as a microprocessor core, provided in a language such as LISA and use this to automatically generate a cycle accurate model of that programmable device. This cycle accurate model provides simulation code which can be run upon a host processor, such as a high performance general purpose computer, to investigate the behaviour of the programmable device being simulated. It is known to use simulation code in this way to simulate a target device being used to execute program code. However, the model of the programmable device may itself contain bugs which need to be identified and fixed. The program code being subject to simulated execution may similarly contain bugs which need to be identified and fixed. Difficulty arises in that when a simulation is being run and produces unexpected results, it can be hard to determine whether the problem lies with the simulation of the hardware or with the program code being subject to simulated execution. In particular, the simulation code which is simulating the hardware executing the program code can show unexpected behaviour indicative of a fault and yet it is difficult to determine from the state of the simulation code simulating the behaviour of the hardware what point has been reached in the program code execution and what was the modelled architectural state of the programmable device which had been reached.

### SUMMARY OF THE INVENTION

Viewed from one aspect the present invention provides a method of debugging a simulation of a target programmable device executing target program code, said method comprising the steps of:

executing simulation code upon a host processor to simulate operation of said target programmable device executing said target program code, said simulation code being operable to maintain a store of current values of target resources of said target programmable device being simulated;

executing a simulation host debugger to provide access to host resources of said host processor during execution of said simulation code by said host processor; and

executing a target device debugger to provide access to said target resources during simulated execution of said target program code by said target programmable device; wherein

execution of said simulation host debugger and said target device debugger are synchronised and said target device debugger accesses said target resources by sending an access request to a debug interface of said target programmable device provided by said simulation code to trigger return of said target resources to said target device debugger.

The present technique provides a system which is able to provide access to both the target device resources giving information regarding the architectural state of the target programmable device being simulated, and accordingly an indication as to whether or not the program code is behaving as expected, as well as access to the host simulation resources thereby enabling an assessment as to whether or not the model simulating the target programmable device is properly defined and is behaving as expected. This simultaneous access to both the host simulation resources and the target device resources is enabled by the provision of the debug interface for the target programmable device within the simulation code via which target device resources stored by the simulated code can be accessed and delivered to the target device debugger. The simulation code thus stores and provides access to target resource data for use in assessing the correct behaviour of the target device in response to execution of the program code as well as providing access to its own host simulation resources such that the accuracy of the simulation itself can be checked. The provision of these two views of the behaviour of the simulation is advantageous in more rapidly developing accurate models of target devices and allows the behaviour of the simulator as well as the behaviour of the target device to be tracked in synchronism such that bugs may be more readily identified.

It will be appreciated that the debug interface could be provided in a number of different ways. One simple possible example would be to ensure that the simulation code stores the target resources at known memory locations, or locations identified by a suitable pointer, such that the target device debugger could access then those resources when required. However, a preferred way of providing the debug interface, which is more flexible and scaleable, is to provide a target device debug application program interface (API) within the simulation code such that a read request issued to that API can trigger return of the target resources stored by the simulation code. This gives greater freedom in the way in which the simulation code provides for the storage of the target resources and responds to target resource access requests.

In some embodiments the access request may be sent from the target device debugger via the host simulation debugger to the debug interface and returned via the same route. This frees the target device debugger from the need to communicate directly with the simulation code whereas the host simulation debugger is already communicating with that simulation code and already has appropriate mechanisms in place to deliver the access request and accept the returned results.

As an alternative embodiment, which may be advantageous in other circumstances, the simulation code can include a debug server operable to receive access requests directly from the target device debugger and to direct those to a debug interface of one or more target devices being simulated by the simulation code.

A further level of abstraction which increases the flexibility of the system is to provide a master simulation host debugger which is operable to control the simulation host debugger. Thus, the simulation host debugger can more readily be provided in the form of a general purpose debugger for debugging program code whether that is simulation code of the type with which the present technique is concerned or any other code. The custom features relating to the present technique and its use for simulation of target programmable devices can be contained within the master simulation host debugger, which need not itself carry the overhead associated with general purpose debugging which is provided within the simulation host debugger.

The master host simulation debugger can also be responsible for communicating with the target device debugger to synchronise the target device debugger with the master host simulation debugger in order that the behaviour of the simulation and the behaviour of the target device may be appropriately correlated.

The simulation host debugger is preferably responsive to the simulation code reaching predefined reference points to trigger the target device debugger to send an access request such that the target resources available to the target device debugger are up-to-date. Examples of suitable debug reference points include a break point within the simulation code, a watch point within the simulation code, a break point within the target program code or a watch point within the target resources. A break point within the target program code and a watch point within the target resources can be identified by the simulation code itself which includes a target device break point portion serving to identify when the target device being simulated adopts a state for which a break point or a watch point has been set. Conversely, the simulation host debugger serves to monitor the simulation code to identify when the simulation code has reached an appropriate point corresponding to a break point or a watch point for the simulation code.

In the context of a system including a master host simulation debugger, the reaching of debug reference points can be signalled to the target device debugger via such a master host simulation debugger. In a similar way, commands to control execution of the simulation code which may be issued by the target device debugger can be routed via the master host simulation debugger to the simulation code.

Examples of the target resources that may be monitored include the simulated target device register content data, simulated target device memory content data, simulated target device program opcodes being executed, simulated instruction pipeline data, such as register scoreboard information, temporary operand storage and forwarding information, and the like.

The target resources read by the target device debugger are used by the target device debugger to provide debug information indicative of the results of simulated execution of the target program code by the target programmable device. This can effectively be seen to give an architectural, or micro-architectural, view of the behaviour of the target programmable device being simulated.

In a similar way, the host resources may be used to provide debug information indicating a result of the execution of the simulation code and accordingly enable the debugging of that simulation code.

It will be appreciated that the simulation code may in some embodiments simulate the behaviour of a plurality of target programmable devices, such as a SoC which could include a processor code, a DSP core, a VLIW processor etc. The simulation code may also be used to simulate the behaviour of one or more non-programmable target devices, such as, for example, a shared memory, a cache, a timer etc.

Another preferred feature enabled by the present technique is the ability to logically combine break points relating to the target program code with break points related to the simulation code. Thus, a combination of a target program code characteristic with a simulation code characteristic (i.e. the simulation of the target programmable device using a particular part of the model for that target programmable device) can be used to trigger debug events (e.g. halting processing such that the state of the system can be examined to investigate a problem though to be occurring when such a combination is present).

Viewed from another aspect the present invention provides a program product carrying a computer program operable to control a computer to perform the method in accordance with the above described techniques.

Viewed from a further aspect the present invention provides apparatus for debugging a simulation of a target programmable device executing target program code, said apparatus comprising:

a host processor executing simulation code to simulate operation of said target programmable device executing said target program code, said simulation code being operable to store target resources of said target programmable device being simulated;

a simulation host debugger operable to provide access to host resources of said host processor during execution of said simulation code by said host processor; and

a target device debugger operable to provide access to said target resources during simulated execution of said target program code by said target programmable device; wherein

execution of said simulation host debugger and said target device debugger are synchronised and said target device debugger accesses said target resources by sending an access request to a debug interface of said target programmable device provided by said simulation code to trigger return of said target resources to said target device debugger.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a first example embodiment providing simulation of a target programmable device executing target program code;

FIG. 2 illustrates a second example embodiment of simulation of a plurality of target programmable devices executing respective target program code; and

FIGS. 3A and 3B are diagrams schematically illustrating the actions performed by the various elements within the systems of FIGS. 1 and 2 in performing simulation; and

FIG. 4 schematically illustrates a general purpose computer of the type which may be used to implement the above described techniques.

### DESCRIPTION OF THE PREFERRED EMBODIMENTS

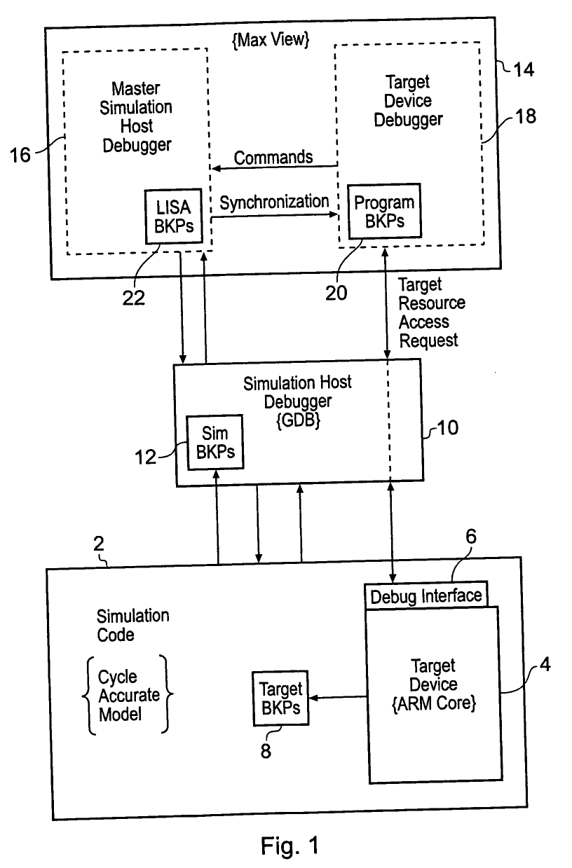

FIG. 1 schematically illustrates a simulation system for simulating a target programmable device executing target program code. Simulation code 2 is developed to provide a cycle accurate model of the target device, such as a microprocessor core. The simulation code 2 can be considered to provide a virtual machine upon which target program code for the target programmable device may be executed. Execution of this target program code upon the simulated target programmable device is advantageous to both test the target programmable device and to test the target program code. In operation, the simulation code 2 is provided with data defining the contents of the program memory (and possibly data to be manipulated) for execution by the target programmable device. The target programmable device is schematically illustrated as element 4 within FIG. 1, although it will be appreciated that the target device is in practice represented by lines of program code within the simulation code and data stored by the simulation code representing the state of the target device.

The simulation code 2 serves to maintain a store of current values of target resources of the target programmable device being simulated. Examples of such target resources are current register values, current memory values, current program opcodes being executed, current pipeline data indicating the state of the instruction pipeline, etc. The simulation code will also contain and maintain considerably more data concerning the target programmable device 4 which is necessary for the simulation code to model cycle accurate behaviour of that target programmable device 4. The simulation code 2 may be generated from and employ in use a machine description language, such as LISA, from which the simulation code may be generated with appropriate tools once the correct LISA description of the target programmable device has been produced. The generation of simulation code from LISA models is a known technique.

Also illustrated in FIG. 1 is a debug interface 6 associated with the target programmable device 4. This debug interface may be a defined memory area within the host processor (the host processor will typically be a high performance workstation being used to conduct this simulation, or a server farm when more performance is required). The debug interface 6 can also be provided in the form of an application program interface within the simulation code 2, which is responsive to requests received by the simulation code 2 and serves to respond to those requests by returning the current copy of the target resource data which is being maintained by the simulation code 2.

Target programmable device break points 8 are monitored by the simulation code 2 such that when the target programmable device 4 reaches a predetermined state known to be of interest, then this is signalled to the various debuggers shown in FIG. 1 and debug action triggered, such as halting the simulation such that the state of the system may be observed, turning trace activities on/off, etc.

The simulation code 2 is itself controlled by a simulation host debugger 10, such as the known GDB debugger. The simulation host debugger 10 can be a general purpose debugger which treats the simulation code 2 substantially as any other item of code to be debugged and provides the resources for debugging that code, such as break point mechanisms 12 which serve to indicate when appropriate points within the simulation code 2 have been reached. Using a generic debugger to serve as the simulation host debugger 10 simplifies implementation.

A master debugger 14 is provided to control the simulation host debugger 10, such as by providing commands to the simulation host debugger and responding to reported events detected by the simulation host debugger 10. Within the master debugger 14 there is provided a master simulation host debugger 16 which serves to control the debugging of the simulation of the target programmable device 4 as well a target device debugger 18 which is used to provide access and give debugging capabilities aimed at the target programmable device 4 executing its target program code. The target device debugger 18 issues a target resource access request via the simulation host debugger 10 which is sent to the debug interface 6 within the simulation code 2. The debug interface 6 returns the current copy of the target resources for the target programmable device for which can then update the state of the target device debugger. Program break points 20 within the target device debugger 18 can be responsive to certain program code points being reached, either device opcode level break points or source program level break points as appropriate. It will be appreciated that a single source level program instruction may map to several opcodes and a break point set on a source code instruction may correspond to multiple break points for each of the opcodes to which that source instructions maps.

The master simulation host debugger 16 is responsible for signalling to the target device debugger 18 that a point within the operation of the simulation code 2 has been reached at which it is appropriate for the target device debugger 18 to request an update of the target resources. Such appropriate points might be program opcode execution boundaries, relevant debug reference points being reached, such as detected break points, watch points or the like, whether those are within the host simulation code or within the state of the target device executing its target program code. The target device debugger 18 can be used to issue commands to start and stop simulation, step through simulation and other commands. These commands are sent via the master simulation host debugger 16 and the simulation host debugger 10 to the simulation code to control the action of that simulation code 2. Break points 22 within the simulation code may also be set within the master simulation host debugger 16. These simulation code break points may refer to reference being made to a particular machine defining state which is thought might be causing a bug within the simulation, or the like. The break points 22 may be logically combined with the break points 20 such that a debug event is triggered only when both events are satisfied or in some other logical combination.

An example of a time at which the target device debugger 18 may issue an access request to the target resources is the simulation code 2 detecting with the target break points 8 that the target programmable device 4 has reached an interesting architectural state, then this is used as a debug reference point and signalled to the target device debugger 18 via the simulation host debugger 10 and the master simulation host debugger 16. The target device debugger 18 can then issue a target resource access request via the simulation host debugger 10 to the debug interface 6 and respond to the returned target resource information to provide debug information for a user. Typical debug information may be the display of register contents, opcodes being executed, simulated instruction pipeline state, memory contents or the like. With such debug information, the target program code can be analysed for correct operation and its interaction with the target programmable device 2 assessed.

The master simulation host debugger 16 is responsive to host resources read from the simulation code 2 to enable debugging of the simulation code 2. Examples of such host resources include host register content data, host memory content data and host program opcodes being executed. Thus, the state of the host system (e.g. the workstation or server farm simulating the target programmable device executing the target program code) may be examined and checked for accuracy and proper behaviour. The host resources are thus used to provide debug information indicating the results of execution of the simulation code 2.

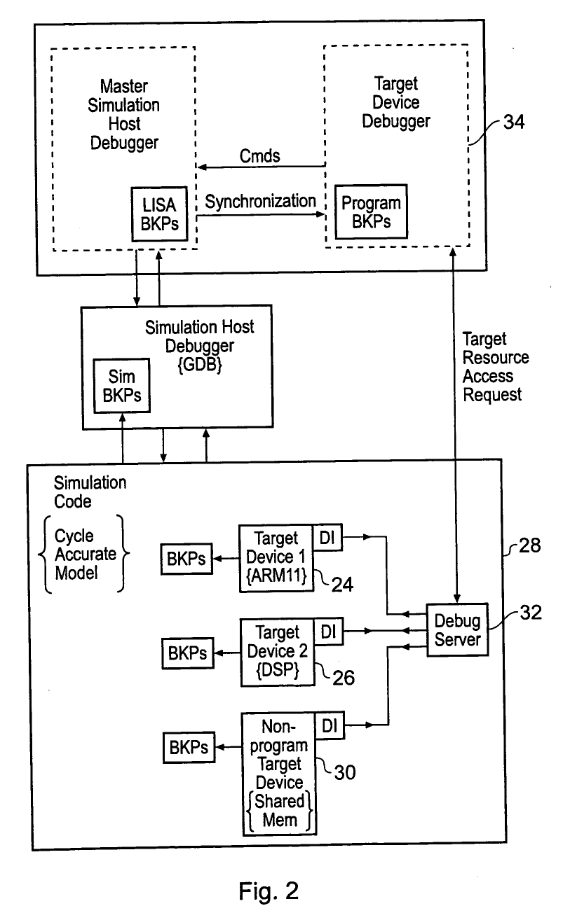

FIG. 2 illustrates a second example embodiment. In this example embodiment multiple target programmable devices 24, 26 are simulated by the simulation code 28. A non-programmable target device 30 is also simulated. Each of these target devices has associated break point control provided for it within the simulation code 28. A debug server 32 serves to receive target resource access requests generated by the target device debugger 34 and direct these to the appropriate debug interface of the intended target device 24, 26, 30. The target resource information returned is routed via the debug server 32 back to the target device debugger 34 where it may be used to debug the relevant target device 24, 26, 30. The target device debugger 34 can thus switch the view that it provides to that of a particular target device. It is also possible for multiple target device debuggers 34 to be provided, each being operable to simultaneously provide debugging information regarding its associated target device 24, 26, 30, this being facilitated by recovery of the target resources via the debug server 32 in order to keep the associated target device debuggers up-to-date.

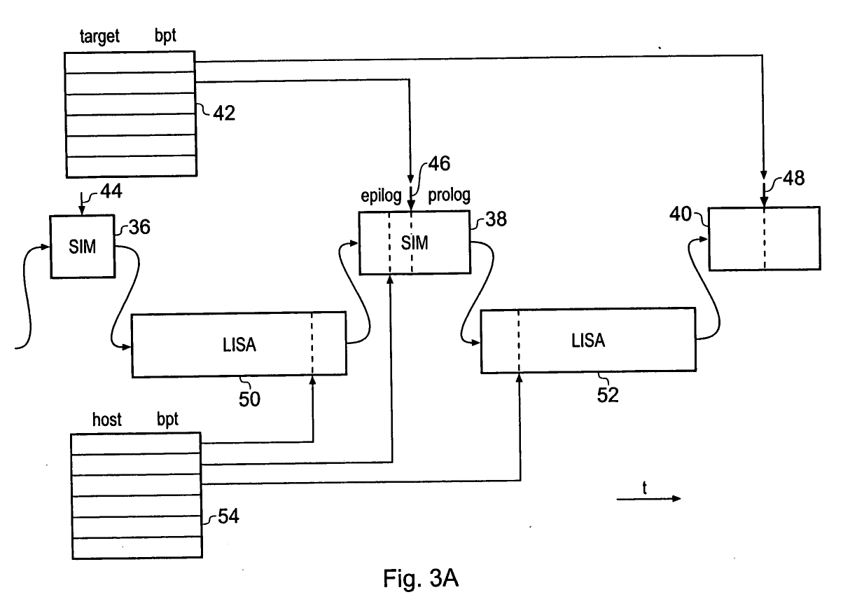

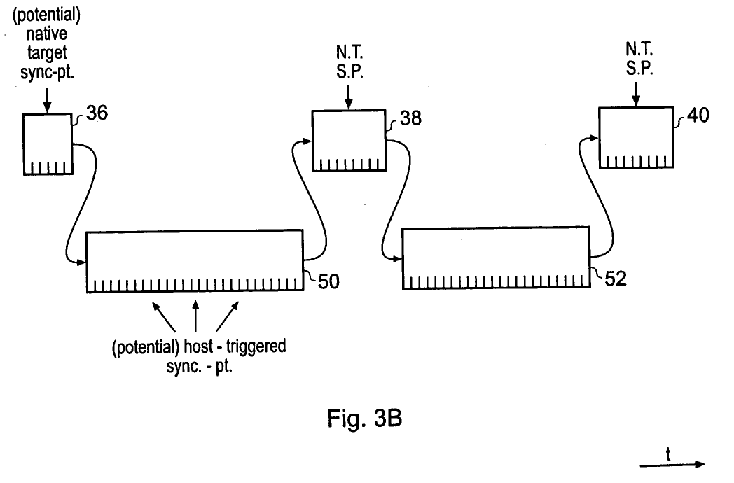

FIGS. 3A and 3B schematically illustrate different simulation levels within the overall system operation and the relationship between these levels and target or host break points and target or host synchronisation points.

FIG. 3A schematically illustrates execution against time. A first level execution portions 36, 38, 40 correspond to the simulation code making updates and taking processing steps directly relating to the target programmable device 4. A list of target programmable device break points 42 specifies debug break points to be applied to the operations of execution portions 36, 38, 40. The specific times 44, 46 and 48 correspond to the points in time at which those simulated target programmable device operations may be interrupted and these points correspond to the behaviour expected in the target programmable device if it were to be subject to a break point in its operation as a physical device or a clock-cycle boundary of the physical device. In particular, the point 46 occurs at the correct point corresponding to the behaviour of the physical device between the processing epilogue on the processing prologue of a given instruction, e.g. checking for target application program breakpoints may have occurred within the epilogue, but clearing the breakpoint flags may not have occurred as this is normally performed in the prologue of the simulation cycle.

Simulation code portions 50, 52 correspond to the processing performed on the host system to support the modelling of the target programmable device. In particular these code portions 50, 52 include the interpretation of the target programmable device description written in LISA. A selection of host break points are provided to debug the operation of this host simulation code 50, 52 in order to debug the model of the target programmable device rather than debugging the target programmable device itself. The code portions 50, 52 can be subject to break points at a much finer level of granularity between almost any host instruction forming part of the simulation code.

FIG. 3B illustrates an alternative view of the code portions 36, 38, 40 corresponding to the manipulation of state of the simulated target programmable device together with the code portions 50, 52 corresponding to the interpretation of the LISA code modelling the target programmable device. It will be seen that for debugging of the program execution of the target programmable device there are a limited number of native target synchronisation points corresponding to what would be the behaviour of that target programmable device when embodied in hardware. Underlying these native target synchronisation points are a series of host device instructions, but interrupting execution at one of these instructions rather than the defined native target synchronisation points would give misleading behaviour since the simulated behaviour and frozen state at those points would not correspond to the actual behaviour of the physical target programmable device in silicon. In contrast to the above, the code portions 50, 52 corresponding to the interpretation of the LISA machine definition, and the other support activities within the simulation code, can be interrupted at a much finer grained level in order to debug the simulation code itself. This finer grain level need not be at every host program instruction but could be, for example, after processing of each LISA instruction intended to model a particular aspect of the target programmable device in order that the correct operation and interaction with other aspects of this system for such individual modelling instructions can be confirmed.

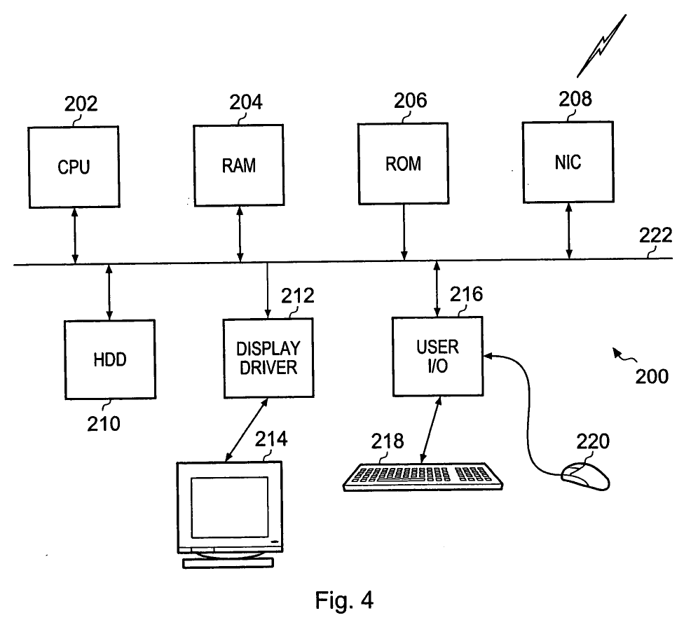

FIG. 4 schematically illustrates a general purpose computer 200 of the type that may be used to implement the above described techniques. The general purpose computer 200 includes a central processing unit 202, a random access memory 204, a read only memory 206, a network interface card 208, a hard disk drive 210, a display driver 212 and monitor 214 and a user input/output circuit 216 with a keyboard 218 and mouse 220 all connected via a common bus 222. In operation the central processing unit 202 will execute computer program instructions that may be stored in one or more of the random access memory 204, the read only memory 206 and the hard disk drive 210 or dynamically downloaded via the network interface card 208. The results of the processing performed may be displayed to a user via the display driver 212 and the monitor 214. User inputs for controlling the operation of the general purpose computer 200 may be received via the user input output circuit 216 from the keyboard 218 or the mouse 220. It will be appreciated that the computer program could be written in a variety of different computer languages. The computer program may be stored and distributed on a recording medium or dynamically downloaded to the general purpose computer 200. When operating under control of an appropriate computer program, the general purpose computer 200 can perform the above described techniques and can be considered to form an apparatus for performing the above described technique. The architecture of the general purpose computer 200 could vary considerably and FIG. 4 is only one example.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of debugging a simulation of a target programmable device executing target program code, said method comprising the steps of:
executing simulation code upon a host processor to simulate operation of said target programmable device executing said target program code, said simulation code being operable to maintain a store of current values of target resources of said target programmable device being simulated;
executing a simulation host debugger to provide access to host resources of said host processor during execution of said simulation code by said host processor; and
executing a target device debugger to provide access to said target resources during simulated execution of said target program code by said target programmable device; wherein
execution of said simulation host debugger and said target device debugger are synchronised and said target device debugger accesses said target resources by sending an access request to a debug interface of said target programmable device provided by said simulation code to trigger return of said target resources to said target device debugger.

2. A method as claimed in claim 1, wherein said debug interface is a target device debug application program interface such that a read request to said target device debug application program interface triggers return of said target resources stored by said simulation code.

3. A method as claimed in claim 1, wherein said access request is sent to said simulation host debugger such that said simulation host debugger then reads said target resources via said debug interface and returns said target resources to said target device debugger.

4. A method as claimed in claim 1, wherein said simulation code includes a debug server operable to receive said access request, to read said target resources via said debug interface and to return said target resources to said target device debugger.

5. A method as claimed in claim 1, wherein a master simulation host debugger is operable to control said simulation host debugger in response to received commands.

6. A method as claimed in claim 5, wherein said master host simulation debugger and said target device debugger communicate to synchronize said target device debugger with said master simulation host debugger.

7. A method as claimed in claim 1, wherein said simulation host debugger is responsive to said simulation code reaching a debug reference point to trigger said target device debugger to send said access request.

8. A method as claimed in claim 7, wherein said debug reference point is one of:
a breakpoint set within said target program code;
a watchpoint set within said target resources;
a breakpoint within said simulation code; and
a watchpoint set within said host resources.

9. A method as claimed in claim 7, wherein said master host simulation debugger and said target device debugger communicate to synchronize said target device debugger with said master simulation host debugger and said simulation host debugger signals reaching said debug reference point to said master host simulation debugger and said master host simulation debugger signals triggers said target device debugger to send said access request.

10. A method as claimed in claim 6, wherein said target device debugger sends commands to said host simulation debugger to control execution of said simulation code via said master host simulation debugger.

11. A method as claimed in claim 1, wherein said target resources include one or more of:
simulated target device register content data;
simulated target device memory content data;
simulated target device program opcodes being executed; and
simulated instruction pipeline data.

12. A method as claimed in claim 1, wherein said target device debugger is responsive to said target resources to provide debug information indicating a result of said simulated execution of said target program code by said target programmable device.

13. A method as claimed in claim 1, wherein said host resources include one or more of:
host register content data;
host memory content data; and
host program opcodes being executed.

14. A method as claimed in claim 1, wherein said host resources provides debug information indicating a result of execution of said simulation code.

15. A method as claimed in claim 1, wherein said simulation code executed on said host processor simulates operation of a plurality of target programmable devices each executing target program code, said simulation code being operable to store respective target resources of said plurality of target programmable devices being simulated.

16. A method as claimed in claim 15, wherein said target device debugger is operable to provide access to said respective target resources of said plurality of target programmable devices being simulated.

17. A method as claimed in claim 1, wherein said simulation code executed on said host processor simulates operation of one or more non-programmable target devices, said simulation code being operable to store respective target state data indicative of a simulated state of a non-programmable target device.

18. A method as claimed in claim 17, wherein said target device debugger is operable to provide access to said respective target state data of said one or more non-programmable target devices.

19. A method as claimed in claim 1, wherein breakpoints set within said target program code are logically combined with breakpoints set within said simulation code to trigger a debug action.

20. A program product carrying a computer program operable to control a computer to perform the method as claimed in claim 1.

21. Apparatus for debugging a simulation of a target programmable device executing target program code, said apparatus comprising:
a host processor executing simulation code to simulate operation of said target programmable device executing said target program code, said simulation code being operable to store target resources of said target programmable device being simulated;
a simulation host debugger operable to provide access to host resources of said host processor during execution of said simulation code by said host processor; and
a target device debugger operable to provide access to said target resources during simulated execution of said target program code by said target programmable device; wherein
execution of said simulation host debugger and said target device debugger are synchronised and said target device debugger accesses said target resources by sending an access request to a debug interface of said target programmable device provided by said simulation code to trigger return of said target resources to said target device debugger.
